(19) United States
(12) Patent Application Publication
(10) Pub. No.: US 2015/0013336 A1
(43) Pub. Date: Jan. 15, 2015

(54) RENEWABLE ENERGY STORAGE SYSTEM

(71) Applicant: Diamond Engineering Limited, Saffron Walden, Essex (GB)

(72) Inventor: Peter Thomas Dearman, Bishop's Stortford (GB)

(21) Appl. No.: 14/383,870

(22) PCT Filed: Mar. 6, 2013
(86) PCT No.: PCT/GB2013/050552

§ 371 Date: Sep. 8, 2014

(30) Foreign Application Priority Data
Mar. 9, 2012 (GB) 1204188.5

(51) Int. Cl. F03G 6/00; F01K 25/08; F24J 2/34

(52) U.S. Cl. CPC F03G 6/003; F24J 2/34; F01K 25/08
USPC 60/641.8; 126/617; 60/671

(57) ABSTRACT

A solar collector (2) associated with or incorporated in a heat sink (4), such as a concrete slab, powers an organic Rankine cycle heat engine. Preferably, the working fluid can be heated by a second heat source, derived from biomass or waste incineration for example, after the heat sink (4) has cooled down.

### FIELD OF THE INVENTION

This invention relates to a system and apparatus for storing and utilising energy from an intermittent heat source and particularly from a solar collector.

### BACKGROUND OF THE INVENTION

This invention is particularly applicable to heat engines powered by solar collectors but it is also applicable to other heat engines where there is a mismatch between the availability of input energy and the load.

It is self-evident that solar collectors cannot work at night. For continuous operation solar collectors must be supplemented by some means of storing surplus input or output energy. There are several approaches to this problem, such as storing surplus heat in molten salts, but existing solutions are large scale and expensive. The present invention provides a system for storing surplus input energy which is particularly suitable for small scale installations, for example for domestic use.

### SUMMARY OF THE INVENTION

According to the present invention we provide a low or medium temperature heat engine incorporating an external heat source associated with a heat sink.

As indicated above, the invention is particularly advantageous when the heat source is a solar collector.

Preferably, the heat source is embedded in the heat sink. Conveniently, the heat sink is concrete or cement, which are cheap and readily available. The heat sink may be a slab substantially 50 to 100 mm thick. Domestic or smaller scale industrial solar collectors are often roof-mounted. Depending on the structure and materials, the roof may also function as the heat sink.

A heat engine is a system that performs the conversion of heat or thermal energy to mechanical work. It does this by bringing a working substance from a high temperature state to a lower temperature state. The thermodynamic cycles underlying the operation of a heat engine are well known.

A prevalent closed loop power generation cycle using an external heat source is the Rankine cycle. The circulating fluid is usually water. The Rankine cycle has four stages:
(a) A liquid is pumped from low to high pressure;
(b) The high-pressure liquid is heated at constant pressure to become a dry saturated vapour;
(c) The vapour passes through an expander and performs mechanical work, for example on a turbine; and
(d) The vapour condenses to become a saturated liquid which is recirculated into stage (a).

It is common knowledge that the efficiency of a heat engine is dependent on the temperature difference between the high temperature heat source and the low temperature portion of the cycle. Except for very large scale and complex solar arrays, the temperatures attainable from a solar collector are too low for efficient operation of a conventional Rankine cycle engine using water as the working fluid.

A modification of the Rankine cycle known as the organic Rankine cycle uses a working fluid having a boiling point lower than that of water. A organic Rankine cycle engine can achieve practical efficiencies at comparatively lower temperatures. Our invention is particularly advantageous when used with the organic Rankine cycle.

To improve efficiency, the temperature of the working fluid at the outlet of the expander should be higher than the condensing temperature of the working fluid. Preferably, the working fluid has a boiling point at normal atmospheric pressure not significantly higher than 10° C. Particularly suitable working fluids are refrigerants or low molecular weight hydrocarbons such as butane or propane.

When the invention is used with the organic Rankine cycle or any other pumped cycle, it is particularly convenient that expansion of the working fluid drives the circulating pump. Expansion of the working fluid can also drive a mechanical power source such as an electricity generator, for example by mounting the pump and power source on the same shaft.

The efficiency of the heat engine can be improved in known matter by including heat exchangers at appropriate points in the circulation. The heat sink or the collectors may be insulated to retain heat.

The heat sink continues to supply energy at times when the solar collector or other heat source cannot match the output load. In order to supplement the solar collector, at least part of the working fluid can be diverted through a second heat source. Preferably, this second heat source is a renewable energy source such as a fermentation vessel. The second heat source may be derived from biomass or waste incineration. The second heat source may be geothermal.

### BRIEF DESCRIPTION OF THE DRAWINGS

FIG. 1 is a flow diagram of an organic Rankine cycle engine according to the present invention and indicating how solar energy stored in the form of heat during the day can be used in the evening and after dark; and

FIG. 2 is a section of a vacuum tube solar collector modified according to a manifestation of our invention.

### DESCRIPTION

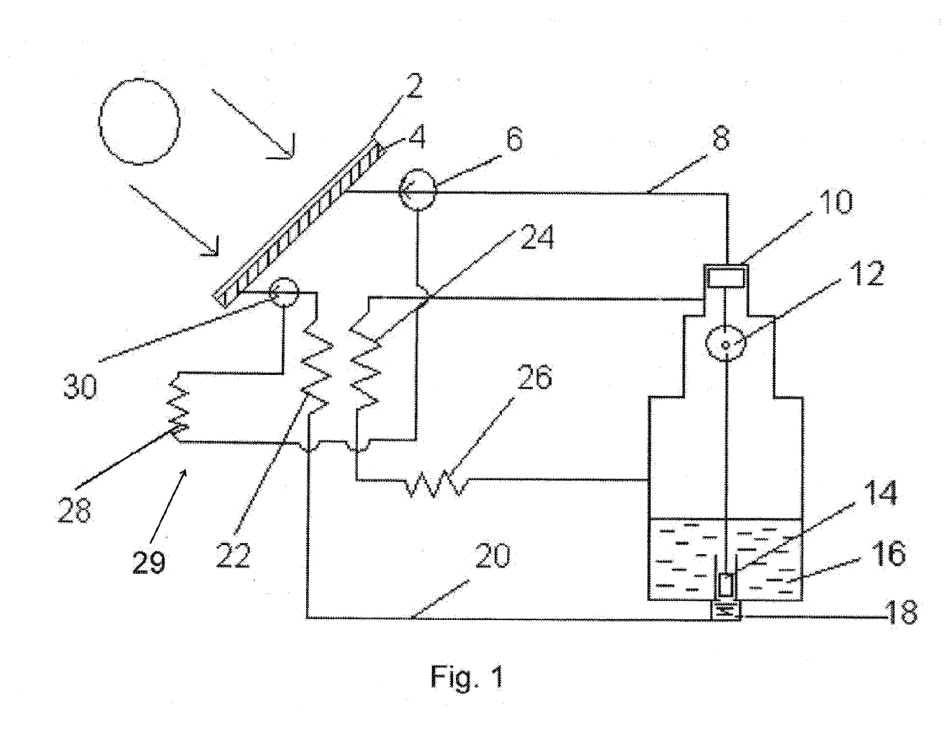

Sunlight, indicated diagrammatically in the upper left-hand corner of FIG. 1, passes through a solar collector 2 and shines on a heat sink 4 consisting of a black painted, concrete slab some 50-100 mm thick. Heat sink 4 is heated by the sun and can remain hot for several hours. Solar collector 2 can be made of clear glass or twin wall polycarbonate, for example. A working fluid such as liquid butane or propane is pumped under pressure through solar collector 2 by means of feed pump 14, check valve 18, pipe 20 and a first heat exchanger 22.

The working fluid is heated as it passes through solar collector 2 and over heat sink 4. The pressurised working fluid leaving solar collector 2 flows along transfer pipe 8 and passes through expander 10, where the expansion pressure is converted to mechanical energy driving feed pump 14. A crank 12 on the same drive shaft is linked to an electricity generator (not shown). Exhaust gas from the expander 10 passes through a second heat exchanger 24, which is a counterpart to first heat exchanger 22. Residual heat in the exhaust gas is transferred to the working fluid passing through first heat exchanger 22 before the working fluid enters the solar collector 2. The exhaust gas is then liquefied by conventional heat exchanger 26 before passing to the inlet of feed pump 14.

At least part of the working fluid can be switched to a bypass loop, indicated generally at 29, by means of switching valves 30 and 6. Working fluid circulating in the bypass loop 29 picks up heat from a heat exchanger 28 associated with a second heat source (not shown) such as a fermentation vessel or a geothermal collector. The second heat source may be derived from biomass or waste incineration. By this means, the heat engine can continue to operate after the heat sink 4 has cooled down.

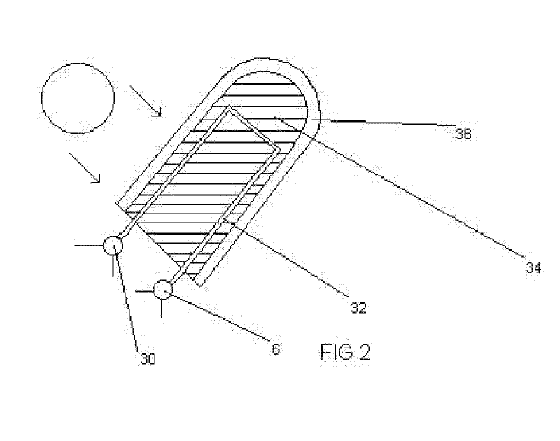

FIG. 2 shows a twin-walled solar collector with an insulating vacuum 36 between the twin walls. The collector is filled with concrete or another heat sink material 34. Pipe 32 is embedded in the heat sink before it sets and the working fluid circulates through pipe 32 as described above.

In summary and without limitation; A solar collector associated with or incorporated in a heat sink, such as a concrete slab, powers an organic Rankine cycle heat engine. Preferably, the working fluid can be heated by a second heat source, derived from biomass or waste incineration for example, after the heat sink has cooled down.

1. A closed loop low or medium temperature heat engine comprising:
an external heat source;
a heat sink associated with the heat source;
an expander; and
a circulating pump,
wherein a working fluid is configured to pass through the expander, and expansion of the working fluid drives the circulating pump.

2. The heat engine as claimed in claim 1, wherein the external heat source is a solar collector.

3. The heat engine as claimed in claim 2, wherein the heat source solar collector is embedded in the heat sink.

4. The heat engine as claimed in claim 3, wherein the heat sink is concrete or cement.

5. The heat engine as claimed in claim 4, wherein the heat sink is a slab of concrete or a slab of cement that is substantially 50 to 100 mm thick.

6. (canceled)

7. A closed loop low or medium temperature heat engine comprising:
an external heat source;
a heat sink associated with the heat source;
an expander; and
a circulating pump,
wherein a working fluid is configured to pass through the expander, and expansion of the working fluid drives the circulating pump, and
wherein the heat engine utilizes the organic Rankine cycle in which the working fluid has a boiling point lower than that of water.

8. (canceled)

9. The heat engine as claimed in claim 7, wherein the working fluid has a boiling point at normal atmospheric pressure not higher than 10° C.

10. The heat engine as claimed in claim 9, wherein the working fluid is butane or propane.

11. (canceled)

12. The heat engine as claimed in claim 7, wherein expansion of the working fluid also drives an electricity generator.

13. The heat engine as claimed in claim 7, wherein at least part of the working fluid is configured to be diverted through a second heat source.

14. The heat engine as claimed in claim 13, wherein the second heat source is a renewable energy source.

15. The heat engine as claimed in claim 14, wherein the second heat source is a fermentation vessel.

16. The heat engine as claimed in claim 14, wherein the second heat source is derived from biomass.

17. The heat engine as claimed in claim 13, wherein the second heat source is derived from waste incineration.

18. (canceled)

19. (canceled)

20. The heat engine as claimed in claim 7, wherein the external heat source is a solar collector.

21. The heat engine as claimed in claim 20, wherein the solar collector is embedded in the heat sink.

22. The heat engine as claimed in claim 21, wherein the heat sink is a slab of concrete or a slab of cement that is substantially 50 to 100 mm thick.

23. The heat engine as claimed in claim 1, wherein the working fluid is butane or propane.

24. The heat engine as claimed in claim 1, wherein at least part of the working fluid is configured to be diverted through a second heat source.

25. The heat engine as claimed in claim 1, wherein the second heat source is a renewable energy source.
